(19) United States
(12) Patent Application Publication
(10) Pub. No.: US 2018/0071058 A1
(43) Pub. Date: Mar. 15, 2018

(54) SINGLE IMPLANT WITH DUAL WINGS AND DUAL WINGED IMPLANT WITH CONNECTING BAR OR PLATE

(71) Applicant: JONATHON YIGAL YAHAV, SKOKIE, IL (US)

(72) Inventor: JONATHON YIGAL YAHAV, SKOKIE, IL (US)

(21) Appl. No.: 15/261,129

(22) Filed: Sep. 9, 2016

(51) Int. Cl. A61C 8/00; A61C 8/02

(52) U.S. Cl. CPC A61C 8/0033; A61C 8/0019; A61C 8/0006; A61C 8/0027; A61C 8/0037

(57) ABSTRACT

A dental implant has a substantially cylindrical configuration and a pair of wing members projecting outwardly from diametrically opposite side wall portions of the implant. The wing members have a substantially right triangular configuration with one leg of each right triangle effectively connecting the wing member to the body of the implant, the other leg of the right triangle extending outwardly from the body of the implant at an orientation that is perpendicular to the longitudinal axis of the implant body, and the hypotenuse side of the right triangle being radiused so as to promote osseointegration. In addition, two winged implants may be connected together by means of a connecting bar or plate. In accordance with this dual implant, the wing members are only provided upon the laterally external side wall portions of each implant while the oppositely disposed internal portions of each implant are integrally connected to the intermediary connecting bar or plate. The undersurface of the connecting bar or plate is likewise radiused so as to promote osseointegration.

### FIELD OF THE INVENTION

The present invention relates generally to dental implants, and more particularly to a dental implant which has a substantially cylindrical configuration and a pair of wing members projecting outwardly from diametrically opposite side wall portions of the implant. The wing members have a substantially right triangular configuration with one leg of each right triangle effectively connecting the wing member to the body of the implant, the other leg of the right triangle extending outwardly from the body of the implant at an orientation that is perpendicular to the longitudinal axis of the implant body, and the hypotenuse side of the right triangle being radiused so as to promote osseointegration. In addition, two winged implants may be connected together by means of a connecting bar or plate. In accordance with this dual implant, the wing members are only provided upon the laterally external side wall portions of each implant while the oppositely disposed internal portions of each implant are integrally connected to the intermediary connecting bar or plate. The undersurface of the connecting bar or plate is likewise radiused so as to promote osseointegration.

### BACKGROUND OF THE INVENTION

Various different types of single winged dental implants, as well as double or multiple winged implants connected together by means of connecting bars, plates, or other structures, are of course well-known. Examples of single dental implants having widely diverse structures include U.S. Pat. No. 7,059,856 which issued to Marotta on Jun. 13, 2006, U.S. Pat. No. 5,141,435 which issued to Lillard on Aug. 25, 1992, U.S. Pat. Nos. 5,116,226, 5,110,293, and 5,102336 which respectively issued to Linkow on May 26, 1992, May 5, 1992, and Apr. 7, 1992, U.S. Pat. No. 5,032,129 which issued to Kurze et al. on Jul. 16, 1991, and U.S. Pat. No. 4,624,673 which issued to Meyer on Nov. 25, 1986. Examples of dual or multiple implants connected together by means of a connective bar, plate, or similar structure, and having widely diverse structures, include U.S. Pat. No. 8,714,977 which issued to Fromovich et al. on May 6, 2014, U.S. Pat. No. 8,038,442 which issued to Hurson on Oct. 18, 2011, U.S. Pat. No. 5,302,128 which issued to Suga on Apr. 12, 1994, U.S. Pat. Nos. 5,006,070 and 4,802,847 which issued respectively to Komatsu on Apr. 9, 1991 and Feb. 7, 1989, U.S. Pat. No. 4,521,192 which issued to Linkow on Jun. 4, 1985, U.S. Pat. No. 3,992,780 which issued to Herskovits on Nov. 23, 1976, U.S. Pat. No. 3,829,972 which issued to Pasqualini et al. on Aug. 20, 1974, U.S. Pat. No. 3,798,771 which issued to Edelman on Mar. 26, 1974, U.S. Pat. Nos. 3,729,825 and 3,660,899 which respectively issued to Linkow et al. on May 1, 1973 and May 9, 1972, United States Patent Application Publication 2010/0112523 wherein the applicants were Fromovich et al. and the application was published on May 6, 2010, European Patent Application 0517529 wherein the applicant was Inoue and the application was published on Dec. 9, 1992, and International Application WO 2015/050331 wherein the applicant was Rhew and the application was published on Apr. 9, 2015.

While the various prior art patent publications disclose various dental implants comprising diverse structures, it is noted that in connection with those patent publications directed toward a single implant, none of the implants comprise structure which is specifically oriented toward providing or promoting both physical stability and structural stability by means of enhancing, for example, osseointegration, which is critically important to the success of the implant becoming an integrally fixed part of a person's set of teeth. This is likewise seen to be the case in connection with an implant structure comprising multiple implants connected together by means of a connective bar, plate, or similar structure.

A need therefore exists in the art for a new and improved single implant, and/or a new and improved dual implant comprising, for example, a pair of single implants which are connected together by means of a bar, plate, or similar structure, which will provide the implant structure with both physical and structural stability such that the implant structure successfully becomes an integrally fixed part of the person's set of teeth as a result of various structural features of the implant structure which will promote osseointegration, wherein osseointegration is well-known to be defined as that state wherein there is no progressive relative movement between the implant and the bone with which it has direct contact.

### Overall Objectives of the Invention

It is an overall objective of the present invention to provide a new and improved single implant, and/or a new and improved dual implant comprising, for example, a pair of single implants which are connected together by means of a bar, plate, or similar structure, which will provide the implant structure with both physical and structural stability such that the implant structure successfully becomes an integrally fixed part of the person's set of teeth as a result of various structural features of the implant structure which will promote osseointegration, wherein osseointegration is well-known to be defined as that state wherein there is no progressive relative movement between the implant and the bone with which it has direct contact.

### SUMMARY OF THE INVENTION

The foregoing and other objectives are achieved in accordance with the teachings and principles of the present invention through the provision of a new and improved single implant, as well as a new and improved dual implant comprising, for example, a pair of single implants which are connected together by means of a bar, plate, or similar structure, wherein the single implant has a body which has a substantially cylindrical configuration and a pair of wings projecting radially outwardly from oppositely disposed external side wall portions of the implant body. The wing members have a substantially right triangular configuration with the vertically oriented leg of each right triangle effectively connecting the wing member to the cylindrical body of the implant, while the horizontally oriented legs of the right triangles extend outwardly from the body of the implant at an orientation that is perpendicular to the longitudinal axis of the implant body. Lastly, the hypotenuse sides of the right triangles of the wing members are radiused, grooves are formed within the upper edge portion of each one of the horizontally oriented legs of the wing members, as well as upon the radiused hypotenuse sides of the wing members, and recesses are also formed within opposite side surfaces of the wing members. Still yet further, circumferential ring members are formed within upper, central, and lower external surface portions of the implant body so as to effectively interrupt the transmission of impact forces generated during the chewing of food, and bone morphogenic protein-2 (BMP-2) is disposed within the various recesses so as to stimulate the production of osteoblast cells for enhanced bone regeneration. In this manner, not only is the implant rendered physically stable within the bone by means of the cylindrical body portion and the provision of the wing members, but in addition, the various grooves, recesses, and circumferential ring members serve as sites within which bone regeneration is permitted to flourish so as to promote osseointegration whereby the implant will in fact be integrally connected to the maxillary or mandible jaw bone. In addition, two winged implants may be connected together by means of a connecting bar or plate. In accordance with this dual implant, the wing members are only provided upon the laterally external side wall portions of each implant body while the oppositely disposed internal portions of each implant are integrally connected to the intermediary connecting bar or plate. The connecting bar or plate has a linear edge portion extending along one of its upper or lower edge portions, depending upon whether or not the dual implant is to be used within the maxillary or upper jaw bone, or within the mandible or lower jaw bone, and the linear edge portion includes a longitudinally extending groove defined therein. The opposite edge portion of the connecting plate or bar is radiused, and the oppositely disposed surface portions of the bar or plate also have recesses formed therein, all of these features likewise being provided so as to promote osseointegration.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic drawing illustrating, for example, the disposition of a single implant, as constructed in accordance with the principles and teachings of the present invention, as implanted within each one of the maxillary or upper jaw bone and the mandible or lower jaw bone;

FIG. 1A is a schematic drawing illustrating, for example, the disposition of a dual implant, as constructed in accordance with the principles and teachings of the present invention, as implanted within the maxillary or upper jaw bone;

FIG. 2 is a schematic drawing illustrating, for example, the disposition of a dual implant, as constructed in accordance with the principles and teachings of the present invention, as implanted within the mandible or lower jaw bone;

FIG. 3 is a perspective view of a single implant as constructed in accordance with the principles and teachings of the present invention;

FIG. 4 is a mechanical drawing illustrating a side elevational view of the single implant as disclosed within FIG. 3;

FIG. 5 is a perspective view of a dual implant as constructed in accordance with the principles and teachings of the present invention wherein a pair of single implants, similar to the single implant shown in FIG. 3, are fixedly secured to opposite ends of an intermediary connecting bar or plate;

FIG. 6 is a perspective drawing of a rotary cutting disk of the type which is utilized to form the radiused slots within the upper or lower jaw bones for accommodating both the radiused hypotenuse sections of the wing members of the implants as well as the radiused edge portion of the connecting bar or plate of the dual implant; and

FIG. 7 is a perspective view of a dual implant, similar to that as shown in FIG. 5, showing, however, the undersurface portions of the wing members and the connecting plate within which grooves are defined for promoting osseointegration.

### DETAILED DESCRIPTION OF THE ILLUSTRATED EMBODIMENTS

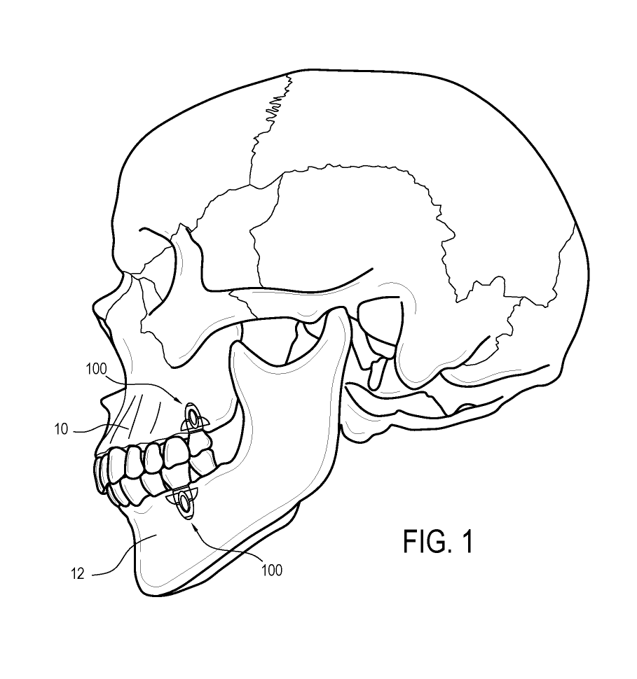

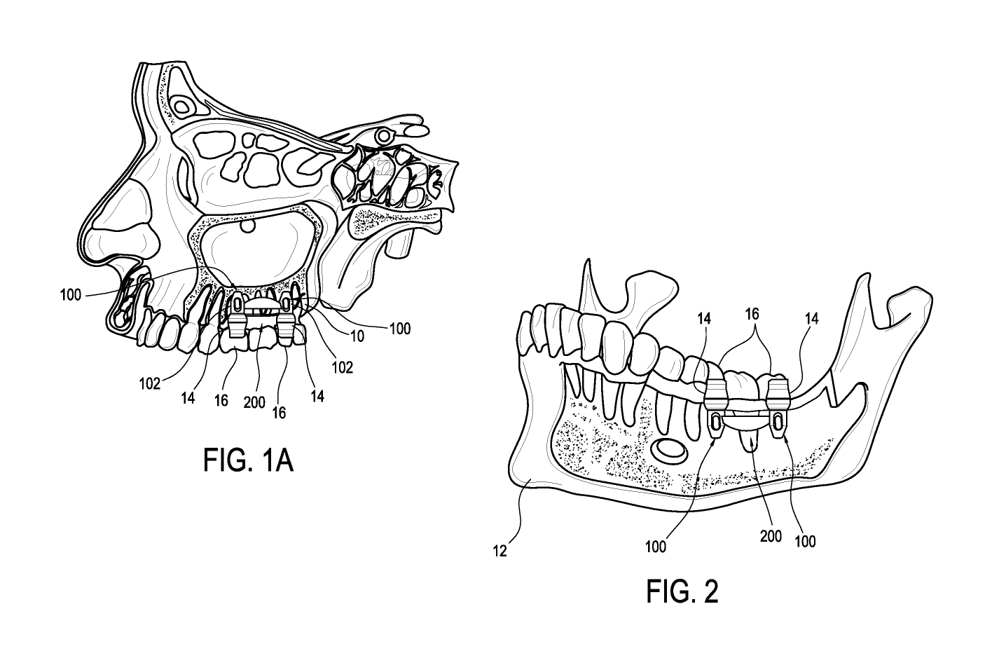

Referring now to the drawings, and more particularly to FIG. 1 thereof, there is schematically shown a first embodiment of a new and improved single dental implant, constructed in accordance with the principles and teachings of the present invention, generally indicated by the reference character 100, and illustrated as being implanted within both the maxillary or upper jaw bone 10 and the mandible or lower jaw bone 12. In a similar manner, and as illustrated within FIGS. 1A and 2, there is schematically shown a second embodiment of a new and improved dual dental implant, constructed in accordance with the principles and teachings of the present invention, generally indicated by the reference character 200, and illustrated as being implanted within both the maxillary or upper jaw bone 10 and the mandible or lower jaw bone 12. Detailed descriptions of both the first and second single and dual winged implants 100,200 will be provided hereinafter, however, with reference first being made to FIGS. 1A and 2, it is initially seen and appreciated, as is known in the art, that each winged implant 100 comprises a substantially cylindrical body portion 102 which is to be implanted within one of the jaw bones 10,12, and that the opposite end of the implant 100 is adapted to have an abutment 14 fixedly secured thereon. In turn, a dental crown 16 is adapted to be fixedly secured to the abutment 14.

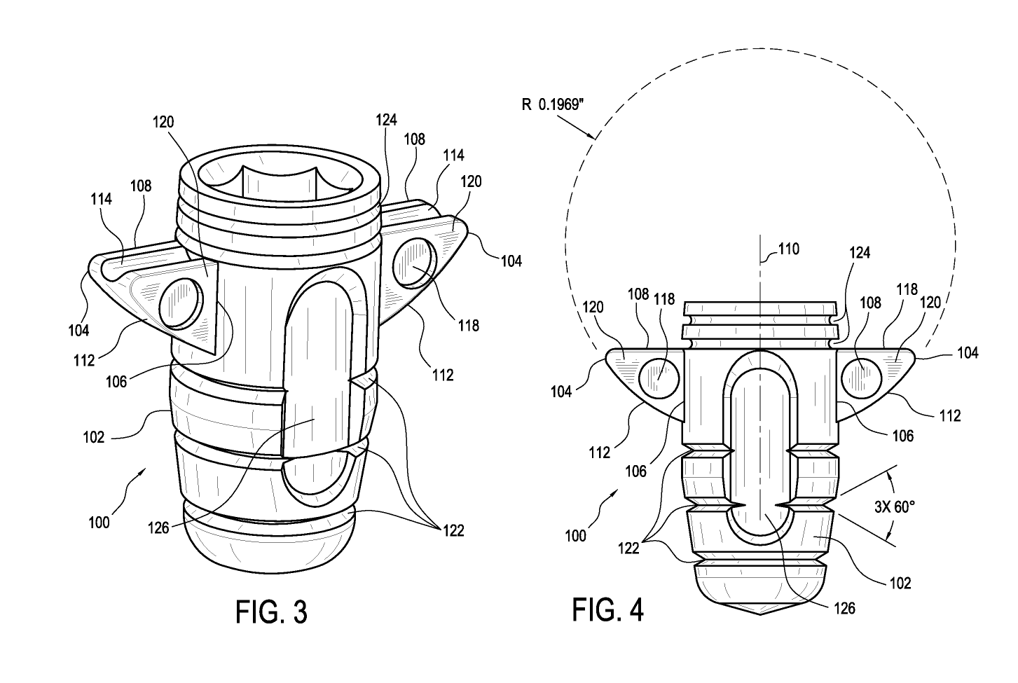

With reference now being made to FIGS. 3 and 4, the new and improved single implant, as constructed in accordance with the principles and teachings of the present invention and as indicated by the reference character 100, will now be described. More particularly, it is seen that the single implant 100 has a body portion 102 which has a substantially cylindrical configuration, and a pair of wings 104,104 projecting radially outwardly from oppositely disposed external side wall portions of the implant body 102. The wing members 104 each have a substantially right triangular configuration with the vertically oriented leg 106 of each right triangle effectively connecting the wing member 104 to the cylindrical body portion 102 of the implant 100, while the horizontally oriented leg 108 of each right triangle extending outwardly from the body portion 102 of the implant 100 at an orientation that is perpendicular to the longitudinal axis 110 of the implant body portion 102. Lastly, the hypotenuse side 112 of each one of the right triangles of each wing member is radiused with a radius dimension of, for example, 0.1969 inches (0.1969″) as can be seen in FIG. 4. A linear groove 114 is formed within the upper edge portion of each one of the horizontally oriented legs 108 of the wing members, and a similar groove, not shown, can be formed within the external radiused edge portion of the hypotenuse side 112 of each one of the wing members 104,104. In addition, recesses 118, having circular configurations, although other geometrical configurations are possible, are formed within opposite side surfaces 120 of the wing members 104. Still yet further, circumferential or annular ring members or cavities 122 are formed within the central and lower external surface portions of the implant body 102. As can be seen from FIG. 4, the annular or circumferential ring members 122 subtend angular extents of 60°. Additional annular or circumferential ring members or cavities 124 are defined within the upper external surface portions of the implant body 102. The annular or circumferential ring members 122,124 are provided so as to effectively interrupt the transmission of impact forces that are generated during the chewing of food, and both sets of annular or circumferential rings members 122,124 serve to permit bone tissue to build up within such cavities so as to effectively define bone connections to the implant 100 in order to firmly affix the implant 100 within the particular jaw bone 10,12 as a result of osseointegration. Still further, in addition to the circular recesses 118 defined upon the wing members 104, an elliptically configured recess 126, having its longitudinal axis disposed parallel to the longitudinal axis 110 of the implant body 102, is defined upon diametrically opposite external portions of the implant body 102. The recesses 118,126 serve to reduce stress forces which would otherwise be developed between the bone and the implant 100 because the bone has spatial areas within which to grow and regenerate. Bone morphogenic protein-2 (BMP-2) is also adapted to be disposed within the various recesses 118,126 defined upon the wing members 104,104 and the implant body 102. The bone morphogenic protein-2 (BMP-2) promotes or stimulates the generation of osteoblasts which enhance bone regeneration.

Continuing further, it is also to be noted that the wing members 104, 104, and the radiused hypotenuse edge portions 112,112 thereof serve additional functions important to the overall structure of the new and improved implant 100 as well as its successful implantation within the upper or lower jaw 10,12. More particularly, after a substantially cylindrical hole is formed within the particular upper or lower jaw bone 10,12 so as to accommodate the cylindrical body portion 102 of the implant 100, radiused slots, not shown, are also formed within the particular jaw bone 10,12, in a transverse manner crossing the hole in the jaw bone for accommodating the cylindrical body portion 102 of the implant 100, so as to accommodate the wing members 104,104. As can be appreciated from FIG. 6, such radiused slots, not shown, may be formed by means of a rotary cutting disk 128. The size of the rotary cutting disk 128 is of course to be such as to correspond to the radiused hypotenuse edge portions 112 of the wing members 104, that is, 0.1969 inches (0.1969″). As can therefore be appreciated, when the implant 100 is in fact inserted into the particular upper or lower jaw bone 10,12, not only is the cylindrical body portion 102 of the implant 100 accommodated within its cylindrical hole formed within the particular jaw bone 10,12, but the pair of wing members 104, 104 are now disposed within their radiused slots. It can therefore be appreciated that the wing members 104,104 provide physical stability for the implant 100 with respect to it disposition within the particular jaw bone 10,12 in that the wing members 104,104 will effectively resist not only linear forces perpendicular to the surfaces 120,120 thereof, but also rotational forces tending to rotate the implant 100 within its cylindrical hole or bore. Still yet further, the various grooves, recesses, and circumferential ring members serve as sites within which bone regeneration is permitted to flourish so as to promote osseointegration whereby the implant will in fact be integrally connected to the maxillary or mandible jaw bone 10,12. In particular, the provision of the radiused slots, not shown, for accommodating the radiused hypotenuse edge portions 112,112 of the wing members 104,104 enhance bone growth and osseointegration because bone growth prefers smooth, sloped surfaces upon which to generate.

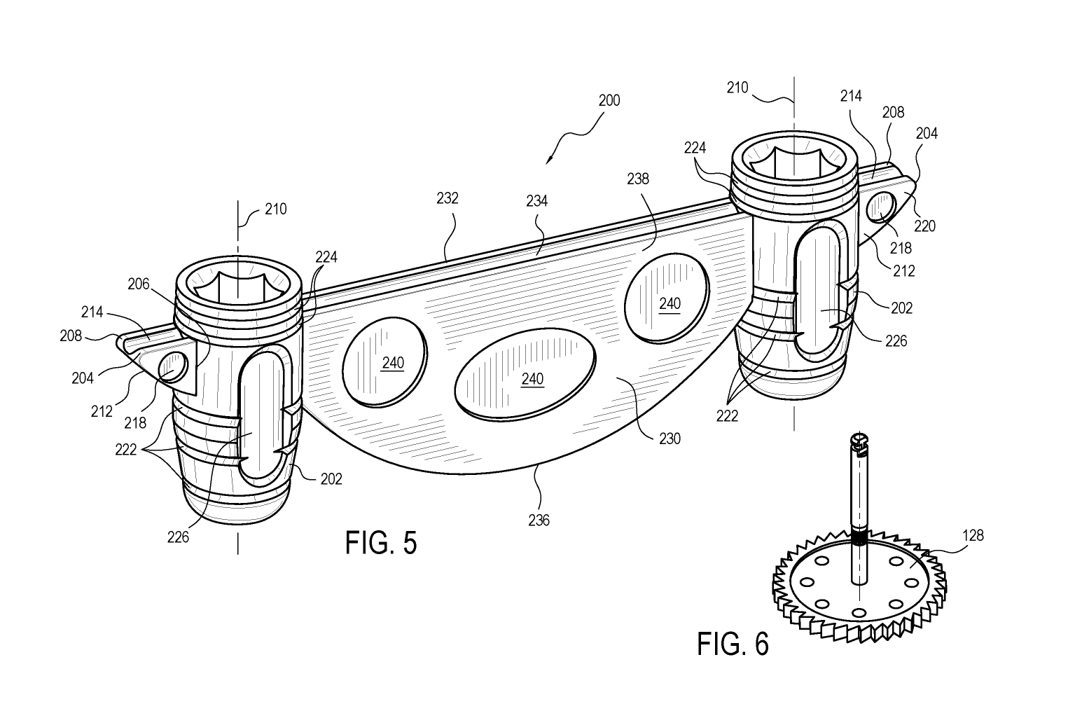

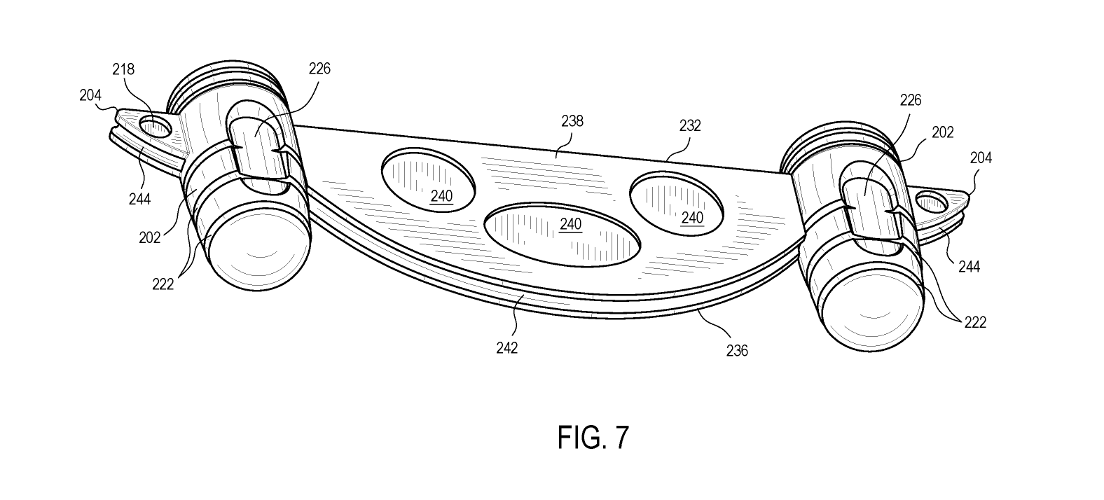

With reference now being made to FIGS. 5 and 7, a second embodiment dual implant of the present invention is disclosed and is generally indicated by the reference character 200. This second embodiment dual implant 200 is seen to effectively comprise two single implants, similar to the single implant 100 illustrated in FIGS. 3 and 4, however, in addition to the utilization of two single implants 100, 100, the single implants 100 are effectively connected together by means of an intermediary connecting bar or plate 230. It is to be noted that components parts of the second embodiment dual implant 200 which correspond to component parts of the first embodiment single implant 100 will be designated by corresponding reference characters except that they will be in the 200 series, although for brevity purposes, such corresponding components parts will not be discussed in detail.

To the contrary, the description of the second embodiment dual implant 200 will focus upon the differences between the first embodiment single implant 100 and the second embodiment dual implant 200. For example, it is to be noted that the wing members 204,204 are only provided upon the laterally external side wall portions of each implant body 202 while the oppositely disposed internal portions of each implant body portion 202 are integrally connected to the intermediary connecting bar or plate 230. In addition, or more particularly, it is also noted that the wing members 204,204 extend radially outwardly from their respective implant body portions 202 in diametrically opposite directions. The connecting bar or plate has a linear edge portion 232 extending along one of its upper or lower edge portions, depending upon whether or not the dual implant 200 is to be used within the maxillary or upper jaw bone 10, or within the mandible or lower jaw bone 12, and the linear edge portion 232 includes a longitudinally extending groove 234 defined therein. The opposite edge portion 236 of the connecting plate or bar 230 is radiused, and the oppositely disposed surface portions 238 of the connecting bar or plate 230 have a plurality of recesses 240 formed therein, all of these features likewise being provided so as to promote osseointegration as has been discussed hereinbefore in connection with the first embodiment single implant 100. It is to be noted that similar to the longitudinal groove 234 defined within the linear edge portion 232, the radiused edge portion 236 can likewise be provided with a groove 242, and still further, the underside radiused portions of the wing members 204,204 can also be provided with similar grooves 244,244.

Obviously, many variations and modifications of the present invention are possible in light of the above teachings. It is therefore to be understood that within the scope of the appended claims, the present invention may be practiced otherwise than as specifically described herein.

### KEY TO REFERENCE NUMBERS

10—Upper or maxillary jaw bone
12—Lower or mandible jaw bone
14—Abutment disposed upon outwardly projecting end of implant 100
16—Crown disposed upon abutment 14
100—First embodiment single implant with opposite wing members
102—Body portion of implant 100
104—Wing members on implant 100
106—Vertically oriented leg of right triangle configured wing member 104
108—Horizontally oriented leg of right triangle configured wing member 104
110—Longitudinal axis of implant body portion 102
112—Hypotenuse side of right triangle configured wing member 104
114—Linear groove in upper edge portion of 108
118—Recesses in side surface portions 120 of wing members 104
120—Side surface portions of wing members 104
122—Ring members/cavities in central, lower external portions of 102
124—Ring members/cavities in upper external portions of 102
126—Elliptical recesses in body portion 102 of implant 100
128—Rotary cutting disk
200—Second embodiment dual winged implant
202—Implant body portion
204—Wing member
230—Connecting bar or plate of 200
232—Linear edge portion of 230
234—Linear groove within linear edge portion 232
236—Radiused edge portion of 230
238—Opposite surface portions of 230
240—Recesses within surface portions 238
242—Groove in radiused underside portion of 236
244—Grooves in radiused hypotenuse sides of wing members 204,204

What is claimed as new and desired to be protected by Letters Patent of the United States of America, is:

1. A single dental implant to be implanted within a jaw bone of a person, comprising:
an implant body portion defined around a longitudinal axis;
a pair of wing members projecting radially outwardly from diametrically opposite side wall portions of said implant body portion; and
at least one circumferential ring member defined within an external surface portion of said implant body portion for interrupting impact forces generated during the chewing of food once said single dental implant has been implanted within a jaw bone of a person.

2. The dental implant as set forth in claim 1, wherein:
each one of said pair of wing members has a substantially right triangular configuration.

3. The dental implant as set forth in claim 2, wherein:
a vertically oriented leg of each one of said pair of right triangular wing members integrally connects said wing member to said implant body portion, while a horizontally oriented leg of each one of said pair of right triangular wing members extends perpendicular to said longitudinal axis of said implant body.

4. The dental implant as set forth in claim 3, wherein:
a hypotenuse side of each one of said right triangular wing members connects said vertically oriented and horizontally oriented legs of said wing members, and said hypotenuse sides of said wing members are radiused.

5. The dental implant as set forth in claim 4, wherein:
said radiused hypotenuse sides of said wing members are adapted to be accommodated within radiused slots formed within the jaw bone within which the dental implant is to be implanted.

6. The dental implant as set forth in claim 1, wherein:
said at least one circumferential ring member defined within an external surface portion of said implant body portion comprises a plurality of circumferential ring members formed within upper, central, and lower external peripheral surface portions of said implant body portion.

7. The dental implant as set forth in claim 1, wherein:
at least one first recess is defined within at least one side surface portion of at least one of said pair of wing members so as to permit bone regeneration to occur within said at least one first recess of said at least one wing member.

8. The dental implant as set forth in claim 7, wherein:
at least one second recess is defined within at least one external side surface portion of said implant body portion so as to permit bone regeneration to occur within said at least one recess of said implant body portion.

9. The dental implant as set forth in claim 8, wherein:
said at least one first recess defined within said at least one side surface portion of said at least one wing member, and said at least one second recess defined within at least one external side surface portion of said implant body portion, have bone morphogenic protein-2 (BMP-2) disposed within said at least one first recess portion defined within said at least one side surface portion of said at least one wing member and within said at least one second recess defined within at least one external side surface portion of said implant body portion so as to permit bone regeneration to occur within said at least one first recess portion defined within said at least one side surface portion of said at least one wing member and within said at least one second recess defined within said at least one external side surface portion of said implant body portion.

10. The dental implant as set forth in claim 3, wherein:
a linear groove is defined within an upper edge portion of at least one of said horizontally oriented legs of at least one of said wing members for permitting bone growth regeneration to occur within said linear groove.

11. A dual dental implant to be implanted within a jaw bone of a person, comprising:
a pair of implant body portions;
a wing member projecting radially outwardly, respectively, in diametrically opposite directions from side wall portions of said pair of implant body portions;
a connecting bar or plate interconnecting said pair of implant body portions together; and
at least one circumferential ring member defined within an external surface portion of each one of said implant body portions for interrupting impact forces generated during the chewing of food once said single dental implant has been implanted within a jaw bone of a person.

12. The dual dental implant as set forth in claim 11, wherein:
each one of said wing members has a substantially right triangular configuration.

13. The dual dental implant as set forth in claim 12, wherein:
a vertically oriented leg of each one of said pair of right triangular wing members integrally connects said wing member to said implant body portion, while a horizontally oriented leg of each one of said pair of right triangular wing members extends perpendicular to said longitudinal axis of said implant body.

14. The dual dental implant as set forth in claim 13, wherein:
a hypotenuse side of each one of said right triangular wing members connects said vertically oriented and horizontally oriented legs of said wing members, and said hypotenuse sides of said wing members are radiused.

15. The dual dental implant as set forth in claim 14, wherein:
said radiused hypotenuse sides of said wing members are adapted to be accommodated within radiused slots formed within the jaw bone within which the dental implant is to be implanted.

16. The dual dental implant as set forth in claim 11, wherein:
said at least one circumferential ring member defined within an external surface portion of said implant body portion comprises a plurality of circumferential ring members formed within upper, central, and lower external peripheral surface portions of said implant body portion.

17. The dual dental implant as set forth in claim 11, wherein:
at least one first recess is defined within at least one side surface 1 portion of at least one of said pair of wing members so as to permit bone regeneration to occur within said at least one first recess of said at least one wing member.

18. The dual dental implant as set forth in claim 17, wherein:
at least one second recess is defined within at least one external side surface portion of each one of said pair of implant body portions so as to permit bone regeneration to occur within said at least one recess of said implant body portion.

19. The dual dental implant as set forth in claim 18, wherein:
said at least one first recess defined within said at least one side surface portion of said at least one wing member, and said at least one second recess defined within at least one external side surface portion of said pair of implant body portions, have bone morphogenic protein-2 (BMP-2) disposed within said at least one first recess portion defined within said at least one side surface portion of said at least one wing member and within said at least one second recess defined within said at least one external side surface portion of said pair of implant body portions so as to permit bone regeneration to occur within said at least one first recess portion defined within said at least one side surface portion of said at least one wing member and within said at least one second recess defined within said at least one external side surface portions of said pair of implant body portions.

20. The dual dental implant as set forth in claim 11, wherein:
said connecting bar or plate interconnecting said pair of implant body portions together has a linear edge portion and an oppositely disposed radiused portion.

21. The dual dental implant as set forth in claim 20, wherein:
a linear groove is defined within said linear edge portion of said connecting bar or plate for permitting bone growth regeneration to occur within said linear groove.

22. The dual dental implant as set forth in claim 11, wherein:
at least one recess is defined within at least one side surface portion of said connecting bar or plate for permitting bone growth regeneration to occur within said at least one recess.

23. The dual dental implant as set forth in claim 8, wherein:
said at least one recess defined within said at least one side surface portion of said connecting bar or plate has bone morphogenic protein-2 (BMP-2) disposed within said at least one recess portion defined within said at least one side surface portion of said connecting bar or plate so as to permit bone regeneration to occur within said at least one recess portion defined within said at least one side surface portion of said connecting bar or plate.
